(19) United States
(12) Patent Application Publication
(10) Pub. No.: US 2022/0129708 A1
(43) Pub. Date: Apr. 28, 2022

(54) SEGMENTING AN IMAGE USING A NEURAL NETWORK

(71) Applicant: Applied Materials Israel Ltd., Rehovot (IL)

(72) Inventors: Elran Gamzo, Rehovot (IL); Tomer Peled, Rehovot (IL)

(21) Appl. No.: 17/496,156

(22) Filed: Oct. 7, 2021

Related U.S. Application Data
(60) Provisional application No. 63/094,905, filed on Oct. 22, 2020.

(51) Int. Cl. G06K 9/62; G06N 3/08

(52) U.S. Cl. CPC G06K 9/6262; G06K 9/6218; G06N 3/08; G06K 9/6261; G06K 9/6256; G06K 9/628

(57) ABSTRACT

A method for image segmentation includes receiving, by a processing device, an image. The method further includes applying a machine learning model to the image, wherein the machine-learning model is trained by a training process comprising evaluating training outputs generated during the training process using a loss function. The method further includes obtaining, for each pixel of multiple pixels of the image, an output of the machine learning model within a multi-dimensional domain, wherein the output is obtained by providing the machine-learning model with pixels of different classes of segments of the image that are mapped to spaced apart clusters associated with different axes of the multi-dimensional domain. The method further includes determining, using the machine-learning model and for each pixel of multiple pixels of the image, a class of a segment that comprises the pixel by finding a closest axis to the output.

### RELATED APPLICATION

This application claims the benefit of U.S. Provisional Application No. 63/094,905, filed Oct. 22, 2020, the entire content of which is hereby incorporated by reference.

### TECHNICAL FIELD

The present disclosure relates to electrical components, and, more particularly, to methods and mechanisms for segmenting an image using a neural network.

### BACKGROUND

Image segmentation involves segmenting an image to multiple segments. An image may be segmented by determining, for each pixel of the image, a class of segment that includes the pixel. Current neural network image segmentation methods include a training phase in which a neural network is fed with a large dataset that includes a large number (thousands, tens of thousands and even millions of images) that are labeled in a consistent manner. Alternatively, the neural network may be fed by multiple large datasets that that are labeled using common taxonomy. Current neural network image segmentation methods may also include neural network processing that provides a neural network result. The neural network result is followed by a complex and time consuming post processing phase of determining, per pixel and based on the neural network result, the class of the segment that includes the pixel. As discussed above, current neural network image segmentation methods require a large dataset of images that were labeled in a consistent manner.

### SUMMARY

The following is a simplified summary of the disclosure in order to provide a basic understanding of some aspects of the disclosure. This summary is not an extensive overview of the disclosure. It is intended to neither identify key or critical elements of the disclosure, nor delineate any scope of the particular implementations of the disclosure or any scope of the claims. Its sole purpose is to present some concepts of the disclosure in a simplified form as a prelude to the more detailed description that is presented later.

In an aspect of the disclosure, an method includes applying a machine learning model to the image, wherein the machine-learning model is trained by a training process comprising inputting into the machine-learning model a plurality of datasets, wherein images of at least two of the plurality of datasets are labeled independently from each other and without using a common taxonomy. The method further includes obtaining, for each pixel of multiple pixels of the image, an output of the machine learning model within a multi-dimensional domain, wherein the output is obtained by providing the machine-learning model with pixels of different classes of segments of the image that are mapped to spaced apart clusters associated with different axes of the multi-dimensional domain. The method further includes determining, using the machine-learning model and for each pixel of multiple pixels of the image, a class of a segment that comprises the pixel by finding a closest axis to the output.

In another aspect of the disclosure, a method includes applying a machine learning model to the image, wherein the machine-learning model is trained by a training process comprising evaluating training outputs generated during the training process using a loss function. The method further includes obtaining, for each pixel of multiple pixels of the image, an output of the machine learning model within a multi-dimensional domain, wherein the output is obtained by providing the machine-learning model with pixels of different classes of segments of the image that are mapped to spaced apart clusters associated with different axes of the multi-dimensional domain. The method further includes determining, using the machine-learning model and for each pixel of multiple pixels of the image, a class of a segment that comprises the pixel by finding a closest axis to the output.

In another aspect of the disclosure, a system comprises a memory and a processing device operatively coupled with the memory. The processing device is configured to perform operations including providing an image as input to a machine-learning model, wherein the machine-learning model is trained by a training process comprising evaluating training outputs generated during the training process using a loss function. The processing device is further configured to perform operations including obtaining, for each pixel of multiple pixels of the image, an output of the machine learning model within a multi-dimensional domain, wherein the output is obtained by providing the machine-learning model with pixels of different classes of segments mapped to spaced apart clusters that are associated with different axes of the multi-dimensional domain. The processing device is further configured to perform operations including determining, using the machine-learning model and for each pixel of multiple pixels of the image, a class of a segment that comprises the pixel by finding a closest axis to the output.

### BRIEF DESCRIPTION OF THE DRAWINGS

The present disclosure is illustrated by way of example, and not by way of limitation in the figures of the accompanying drawings.

FIG. 1 is a block diagram illustrating an exemplary system architecture, according to certain embodiments.

FIG. 2 is a flow diagram of a method for training a machine-learning model, according to certain embodiments.

FIG. 3 depicts an illustration of a training engine, according to certain embodiments.

FIG. 4 illustrates an example of three datasets, each including two images, according to certain embodiments.

FIG. 5 illustrates an example of three datasets and their respective initial classifications, in accordance with embodiments of the present disclosure.

FIG. 6 illustrates an example of the segmentation of the six images, in accordance with embodiments of the present disclosure.

FIG. 7 is a graph illustrating an example of two clusters, in accordance with embodiments of the present disclosure.

FIG. 8 is a flow diagram of a method for segmenting an image using a machine-learning model, according to certain embodiments.

FIG. 9 is a flow diagram of a method for training a machine-learning model, according to certain embodiments.

FIG. 10 is a block diagram illustrating a computer system, according to certain embodiments.

### DETAILED DESCRIPTION

Described herein are technologies directed to methods and mechanisms for segmenting an image using a neural network. Image segmentation is the process of partitioning a digital image into multiple segments (sets of pixels). The goal of segmentation is to simplify or change the representation of an image into something that is more meaningful and easier to analyze. In some examples, image segmentation may be used to locate objects and boundaries in images. In particular, image segmentation can include the process of assigning a label to every pixel in an image such that pixels with the same label share certain characteristic.

Existing image segmentation methods include training a neural network using large dataset of many thousands of images that are labeled in a consistent manner. The output obtained by the neural network is then subject to a complex and time consuming post processing phase of determining, per pixel and based on the neural network result, the class of the segment that includes the pixel. As such, considerable resources (storage, time, computing resources) are required to train a neural network capable of performing image segmentation.

Aspects and implementations of the present disclosure address the shortcomings of the existing technology by training a neural network using different datasets that are labeled independently from each other and labeled without using a common taxonomy. In some embodiments, a neural network may be trained by receiving a set of images from multiple sources that use different labeling schemes. That is, the image datasets may be labeled independently from each other and labeled without using a common taxonomy. For example, different classes in the images from the different datasets can be labeled (e.g., trees are labeled in a first data set and cars are labeled in a second data set), and similar classes in the different datasets can have different labels (e.g., a person can be labeled as “human” in the first dataset and as “other” in the second dataset). The neural network may generate different clusters of neural network outputs for pixels that belong to different classes of segments. Processing logic associated with the training process may then evaluate the neural network outputs using a loss function. The loss function may be a function that computes the distance between the current outputs of the neural network and the expected outputs. In some embodiments, the loss function can include a normalized classification loss function, a one-hot regulation loss function, a cluster mean perpendicular inducing loss function, or any other capable loss function. In some embodiments, one or more of the loss functions may be applied to evaluate the neural network outputs. The processing logic may then perform an optimization operation based on one or more values generated by the loss function. The objective of the optimization operation may be to minimize the loss function (values). In some embodiments, the optimization operation may adjust the connection weights in the neural network based on one or more values generated by the loss function.

The trained neural network may segment an input image by receiving pixels that belong to different classes of segments and output neural network results that are mapped to spaced apart clusters that are associated with different axes of a multi-dimensional domain. In particular, the neural network may determine, for each pixel of multiple pixels of the image, a class of a segment that includes the pixel by finding a closest axis to an intermediate result (e.g., the neural network results). For example, assuming that there are three different classes of segments and there are three axis (e.g., x-axis, y-axis, and z-axis), then the pixels of the first class of segment can be mapped to a first cluster (C1) associated with the x-axis, pixels of the second class of segment can be mapped to a second cluster (C2) associated with the y-axis, and pixels of the third class of segment can be mapped to a third cluster (C3) associated with the z-axis. A cluster is associated with an axis when the neural network outputs of that cluster are proximate to the axis and/or are on the axis. The neural network outputs can be considered to be proximate if, for example, the distance between the neural network outputs that belong to the cluster is closer to the axis associated with the cluster than to the other axes.

Representing the clusters by a limited number of parameters, for example, by two parameters (e.g., their means and standard deviation), and applying the loss functions related to these limited number of parameters greatly simplifies the calculating of the loss functions and greatly simplifies the evaluation of the neural network during the training process. Accordingly, aspects of the present disclosure result in technological advantages of significant reduction in time and computing resources needed to train a neural network for segmenting image data. In addition, obtaining training images from multiple sources that use different labeling schemes reduces storage, time, computing resources and manual operations that are otherwise needed to create large datasets of many thousands of images that are labeled in a consistent manner.

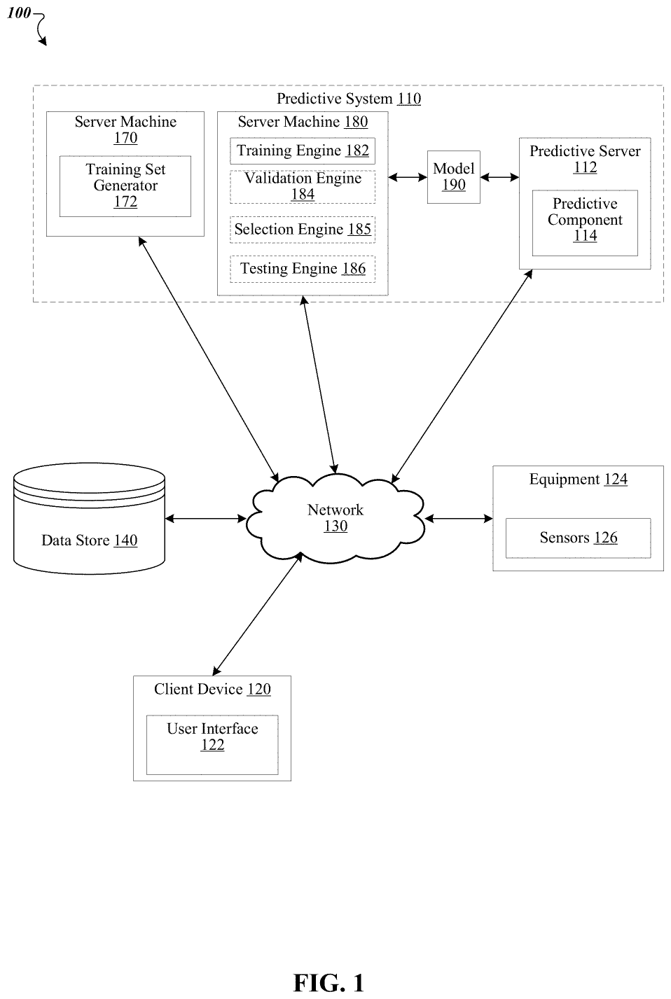

FIG. 1 depicts an illustrative computer system architecture 100, according to aspects of the present disclosure. Computer system architecture 100 includes a client device 120, equipment 124, a predictive server 112 (e.g., to generate predictive data, to provide model adaptation, to use a knowledge base, etc.), and a data store 140. The predictive server 112 can be part of a predictive system 110. The predictive system 110 can further include server machines 170 and 180. In some embodiments, equipment 124 may include a camera, an electron microscope, an optical inspection system, a radar system, a sonar system, or any other device or system capable of generating any type of image. Equipment 124 can include sensors 126 configured to capture or generate an image data (e.g., a camera image, an electron microscope image, an optical inspection system image, a radar image, a sonar image, etc.). In some embodiments, equipment 124 and sensors 126 can be part of a sensor system that includes a sensor server.

The client device 120 may include a computing device such as personal computers (PCs), laptops, mobile phones, smart phones, tablet computers, netbook computers, network connected televisions (“smart TVs”), network-connected media players (e.g., Blu-ray player), a set-top box, over-the-top (OTT) streaming devices, operator boxes, etc. Client device 120 can display a graphical user interface (GUI), where the GUI enables the user to provide user input (e.g., values, selections, etc.). The client device 120 can include a user interface 122. User interface 122 can receive user input (e.g., via a Graphical User Interface (GUI) displayed via the client device 120) of an indication associated with equipment 124. In some embodiments, user interface 122 transmits the indication to the predictive system 110, and receives output (e.g., predictive data) from the predictive system 110. In some embodiments, the predictive data can include an identification of one or more elements in an image (e.g., a cat, a fracture, a boundary, etc.), which may be displayed on the GUI. Each client device 120 may include an operating system that allows users to one or more of generate, view, or edit data (e.g., indication associated with equipment 124, etc.).

Data store 140 can be a memory (e.g., random access memory), a drive (e.g., a hard drive, a flash drive), a database system, or another type of component or device capable of storing data. Data store 140 can include multiple storage components (e.g., multiple drives or multiple databases) that can span multiple computing devices (e.g., multiple server computers). The data store 140 can store data associated with processing image data at equipment 124. For example, data store 140 can store data collected by sensors 126 at equipment 124 before, during, or after an image capturing process (referred to as process data). Process data can refer to historical process data (e.g., process data generated for a prior collection event at equipment 124) and/or current process data (e.g., process data generated during a current event at equipment 124).

In some embodiments, data store 140 can be configured to store label data associated one or more images. Data labeling is the process of identifying raw data (images, text files, videos, etc.) and adding one or more informative labels to provide context so that a machine-learning model can learn from the labeled data. Aspects of data labeling are explained in further detail below.

In some embodiments, predictive system 110 includes predictive server 112, server machine 170 and server machine 180. The predictive server 112, server machine 170, and server machine 180 may each include one or more computing devices such as a rackmount server, a router computer, a server computer, a personal computer, a mainframe computer, a laptop computer, a tablet computer, a desktop computer, Graphics Processing Unit (GPU), accelerator Application-Specific Integrated Circuit (ASIC) (e.g., Tensor Processing Unit (TPU)), etc.

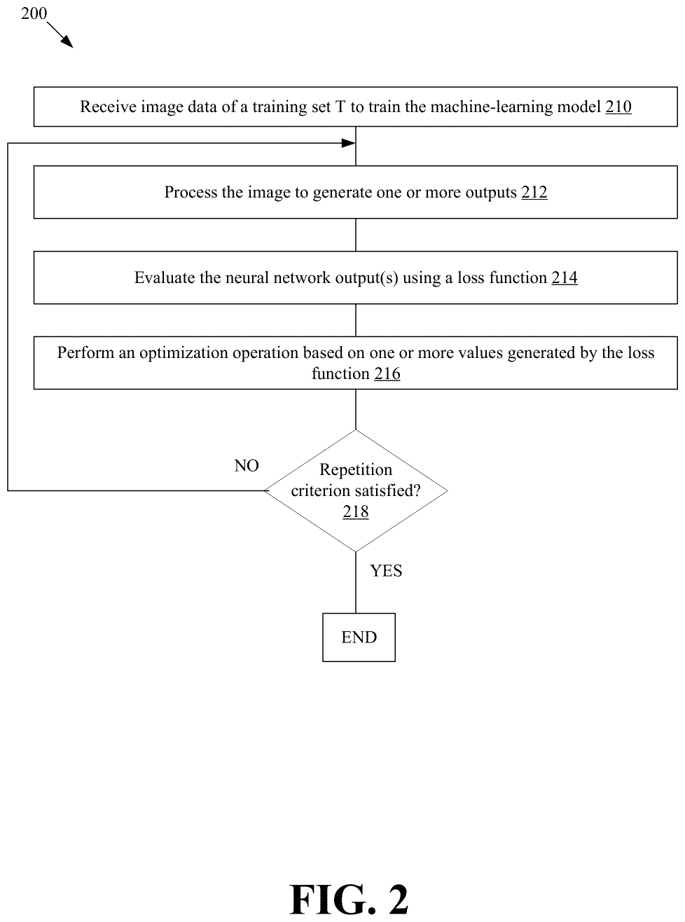

Server machine 170 includes a training set generator 172 that is capable of generating training data sets (e.g., a set of data inputs and a set of target outputs) to train, validate, and/or test a machine-learning model 190. Machine-learning model 190 can be any algorithmic model capable of learning from data. Some operations of data set generator 172 are described in greater detail below with respect to FIG. 2. In some embodiments, the data set generator 172 can partition the training data into a training set, a validating set, and a testing set. In some embodiments, the predictive system 110 generates multiple sets of training data.

Server machine 180 can include a training engine 182, a validation engine 184, a selection engine 185, and/or a testing engine 186. An engine can refer to hardware (e.g., circuitry, dedicated logic, programmable logic, microcode, processing device, etc.), software (such as instructions run on a processing device, a general purpose computer system, or a dedicated machine), firmware, microcode, or a combination thereof. Training engine 182 can be capable of training one or more machine-learning models 190. Machine-learning model 190 can refer to the model artifact that is created by the training engine 182 using the training data (also referred to herein as a training set) that includes training inputs and corresponding target outputs (correct answers for respective training inputs). The training engine 182 can find patterns in the training data that map the training input to the target output (the answer to be predicted), and provide the machine-learning model 190 that captures these patterns. The machine-learning model 190 can use one or more of a statistical modelling, support vector machine (SVM), Radial Basis Function (RBF), clustering, supervised machine-learning, semi-supervised machine-learning, unsupervised machine-learning, k-nearest neighbor algorithm (k-NN), linear regression, random forest, neural network (e.g., artificial neural network), etc.

One type of machine learning model that may be used to perform some or all of the above tasks is an artificial neural network, such as a deep neural network. Artificial neural networks generally include a feature representation component with a classifier or regression layers that map features to a desired output space. A convolutional neural network (CNN), for example, hosts multiple layers of convolutional filters. Pooling is performed, and non-linearities may be addressed, at lower layers, on top of which a multi-layer perceptron is commonly appended, mapping top layer features extracted by the convolutional layers to decisions (e.g. classification outputs). Deep learning is a class of machine learning algorithms that use a cascade of multiple layers of nonlinear processing units for feature extraction and transformation. Each successive layer uses the output from the previous layer as input. Deep neural networks may learn in a supervised (e.g., classification) and/or unsupervised (e.g., pattern analysis) manner. Deep neural networks include a hierarchy of layers, where the different layers learn different levels of representations that correspond to different levels of abstraction. In deep learning, each level learns to transform its input data into a slightly more abstract and composite representation. Notably, a deep learning process can learn which features to optimally place in which level on its own. The “deep” in “deep learning” refers to the number of layers through which the data is transformed. More precisely, deep learning systems have a substantial credit assignment path (CAP) depth. The CAP is the chain of transformations from input to output. CAPs describe potentially causal connections between input and output. For a feedforward neural network, the depth of the CAPs may be that of the network and may be the number of hidden layers plus one. For recurrent neural networks, in which a signal may propagate through a layer more than once, the CAP depth is potentially unlimited.

In one embodiment, one or more machine learning model is a recurrent neural network (RNN). An RNN is a type of neural network that includes a memory to enable the neural network to capture temporal dependencies. An RNN is able to learn input-output mappings that depend on both a current input and past inputs. RNNs may be trained using a training dataset to generate a fixed number of outputs. One type of RNN that may be used is a long short term memory (LSTM) neural network.

Training of a neural network may be achieved in a supervised learning manner, which involves feeding a training dataset consisting of labeled inputs through the network, observing its outputs, defining an error (by measuring the difference between the outputs and the label values), and using techniques such as deep gradient descent and backpropagation to tune the weights of the network across all its layers and nodes such that the error is minimized. In many applications, repeating this process across the many labeled inputs in the training dataset yields a network that can produce correct output when presented with inputs that are different than the ones present in the training dataset.

A training dataset may contain hundreds, thousands, tens of thousands, hundreds of thousands or more image data (e.g., images) that may or may not be labeled and used to form a training dataset.

To effectuate training, processing logic may input the training dataset(s) into one or more untrained machine learning models. Prior to inputting a first input into a machine learning model, the machine learning model may be initialized. Processing logic trains the untrained machine learning model(s) based on the training dataset(s) to generate one or more trained machine learning models that perform various operations as set forth above. Training may be performed by inputting one or more of the image data into the machine learning model one at a time.

The machine learning model processes the input to generate an output. An artificial neural network includes an input layer that consists of values in a data point. The next layer is called a hidden layer, and nodes at the hidden layer each receive one or more of the input values. Each node contains parameters (e.g., weights) to apply to the input values. Each node therefore essentially inputs the input values into a multivariate function (e.g., a non-linear mathematical transformation) to produce an output value. A next layer may be another hidden layer or an output layer. In either case, the nodes at the next layer receive the output values from the nodes at the previous layer, and each node applies weights to those values and then generates its own output value. This may be performed at each layer. A final layer is the output layer, where there is one node for each class, prediction and/or output that the machine learning model can produce.

Accordingly, the output may include one or more predictions or inferences. For example, an output prediction or inference may include one or more predictions of film buildup on chamber components, erosion of chamber components, predicted failure of chamber components, and so on. Processing logic determines an error (e.g., a classification error) based on the differences between the output (e.g., predictions or inferences) of the machine learning model and target labels associated with the input training data. Processing logic adjusts weights of one or more nodes in the machine learning model based on the error. An error term or delta may be determined for each node in the artificial neural network. Based on this error, the artificial neural network adjusts one or more of its parameters for one or more of its nodes (the weights for one or more inputs of a node). Parameters may be updated in a back propagation manner, such that nodes at a highest layer are updated first, followed by nodes at a next layer, and so on. An artificial neural network contains multiple layers of “neurons”, where each layer receives as input values from neurons at a previous layer. The parameters for each neuron include weights associated with the values that are received from each of the neurons at a previous layer. Accordingly, adjusting the parameters may include adjusting the weights assigned to each of the inputs for one or more neurons at one or more layers in the artificial neural network.

After one or more rounds of training, processing logic may determine whether a stopping criterion has been met. A stopping criterion may be a target level of accuracy, a target number of processed images from the training dataset, a target amount of change to parameters over one or more previous data points, a combination thereof and/or other criteria. In one embodiment, the stopping criteria is met when at least a minimum number of data points have been processed and at least a threshold accuracy is achieved. The threshold accuracy may be, for example, 70%, 80% or 90% accuracy. In one embodiment, the stopping criterion is met if accuracy of the machine learning model has stopped improving. If the stopping criterion has not been met, further training is performed. If the stopping criterion has been met, training may be complete. Once the machine learning model is trained, a reserved portion of the training dataset may be used to test the model.

Once one or more trained machine learning models 190 are generated, they may be stored in predictive server 112 as predictive component 114 or as a component of predictive component 114.

The validation engine 184 can be capable of validating machine-learning model 190 using a corresponding set of features of a validation set from training set generator 172. Once the model parameters have been optimized, model validation may be performed to determine whether the model has improved and to determine a current accuracy of the deep learning model. The validation engine 184 can determine an accuracy of machine-learning model 190 based on the corresponding sets of features of the validation set. The validation engine 184 can discard a trained machine-learning model 190 that has an accuracy that does not meet a threshold accuracy. In some embodiments, the selection engine 185 can be capable of selecting a trained machine-learning model 190 that has an accuracy that meets a threshold accuracy. In some embodiments, the selection engine 185 can be capable of selecting the trained machine-learning model 190 that has the highest accuracy of the trained machine-learning models 190.

The testing engine 186 can be capable of testing a trained machine-learning model 190 using a corresponding set of features of a testing set from data set generator 172. For example, a first trained machine-learning model 190 that was trained using a first set of features of the training set can be tested using the first set of features of the testing set. The testing engine 186 can determine a trained machine-learning model 190 that has the highest accuracy of all of the trained machine-learning models based on the testing sets.

As described in more detail below, predictive server 112 can include a predictive component 114 that is capable of providing classification data by running trained machine-learning model 190 on the current image data input to obtain one or more outputs. This will be explained in further detail below.

The client device 120, equipment 124, sensors 126, predictive server 112, data store 140, server machine 170, and server machine 180 can be coupled to each other via a network 130. In some embodiments, network 130 is a public network that provides client device 120 with access to predictive server 112, data store 140, and other publically available computing devices. In some embodiments, network 130 is a private network that provides client device 120 access to equipment 124, data store 140, and other privately available computing devices. Network 130 can include one or more wide area networks (WANs), local area networks (LANs), wired networks (e.g., Ethernet network), wireless networks (e.g., an 802.11 network or a Wi-Fi network), cellular networks (e.g., a Long Term Evolution (LTE) network), routers, hubs, switches, server computers, cloud computing networks, and/or a combination thereof.

It should be noted that in some other implementations, the functions of server machines 170 and 180, as well as predictive server 112, can be provided by a fewer number of machines. For example, in some embodiments, server machines 170 and 180 can be integrated into a single machine, while in some other or similar embodiments, server machines 170 and 180, as well as predictive server 112, can be integrated into a single machine.

In general, functions described in one implementation as being performed by server machine 170, server machine 180, and/or predictive server 112 can also be performed on client device 120. In addition, the functionality attributed to a particular component can be performed by different or multiple components operating together.

In embodiments, a “user” can be represented as a single individual. However, other embodiments of the disclosure encompass a “user” being an entity controlled by a plurality of users and/or an automated source. For example, a set of individual users federated as a group of administrators can be considered a “user.”

FIG. 2 is a flow chart of a method 200 for training a machine-learning model, according to aspects of the present disclosure. Method 200 is performed by processing logic that can include hardware (circuitry, dedicated logic, etc.), software (such as is run on a general purpose computer system or a dedicated machine), firmware, or some combination thereof. In one implementation, method 200 can be performed by a computer system, such as computer system architecture 100 of FIG. 1. In other or similar implementations, one or more operations of method 200 can be performed by one or more other machines not depicted in the figures. In some aspects, one or more operations of method 200 can be performed by server machine 170, server machine 180, and/or predictive server 112.

For simplicity of explanation, the methods are depicted and described as a series of acts. However, acts in accordance with this disclosure can occur in various orders and/or concurrently, and with other acts not presented and described herein. Furthermore, not all illustrated acts can be performed to implement the methods in accordance with the disclosed subject matter. In addition, those skilled in the art will understand and appreciate that the methods could alternatively be represented as a series of interrelated states via a state diagram or events. Additionally, it should be appreciated that the methods disclosed in this specification are capable of being stored on an article of manufacture to facilitate transporting and transferring such methods to computing devices. The term article of manufacture, as used herein, is intended to encompass a computer program accessible from any computer-readable device or storage media.

At operation 210, processing logic receives image data of a training set T to train the machine-learning model. The image data may include a camera image, an electron microscope image, an optical inspection system image, a radar image, a sonar image, etc. In some embodiments, the image data may further include label data. The image data may be obtained from data store 140 or equipment 124. In one implementation, the image data is provided to training engine 182 of server machine 180 to perform the training.

In some embodiments, the training set T can include image data from different data sets. The datasets may be labeled independently from each other and labeled without using a common taxonomy. For example, different classes in the images from different datasets can be labeled (e.g., trees are labeled in a first data set and cars are labeled in a second data set), and similar classes in the different datasets can have different labels (e.g., a person can be labeled as “human” in the first dataset and as “other” in the second dataset).

At operation 212, the processing logic processes the image to generate one or more outputs. By way of example, the machine-learning model may be a neural network and input values of a given input/output mapping associated with the image data are input to the neural network, and output values of the input/output mapping are stored in the output nodes of the neural network. Each neural network output may be located within a multi-dimensional space and has multiple coordinates. The multiple coordinates may be represented by an embedding vector.

At operation 214, the processing logic evaluates the neural network output(s) using a loss function. The loss function may be a function that computes the distance between the current outputs of the algorithm and the expected outputs. The processing logic can generate one or more values using the loss function. In some embodiments, the loss function can include a normalized classification loss function, a one-hot regulation loss function, a cluster mean perpendicular inducing loss function, or any other capable loss function. In some embodiments, one or more of the loss functions may be applied to evaluate the neural network outputs.

At operation 216, the processing logic may perform an optimization operation based on one or more values generated by the loss function. The objective of the optimization operation may be to minimize the loss function (values). In some embodiments, the optimization operation may adjust the connection weights in the neural network based on one or more values generated by the loss function.

At operation 218, the processing logic determines whether a repetition criterion is satisfied. For example, the processing logic can determine whether a value generated by the loss function is below a threshold value, a predetermined amount of repetitions of method 200 have been completed, etc. Responsive to the repetition criterion being unsatisfied (e.g., the value generated by the loss function being above a threshold value, the predetermined amount of repetitions not being completed, etc.), the processing logic proceeds to operation 210. Responsive to the repletion criterion being satisfied, the processing logic ends method 200. In some embodiments, method 200 is repeated for one or more of the remaining items (e.g., input/output mappings) in the training set T.

The multiple repetitions of operations 210-216 may cause the trained neural network to receive image pixels that belong to different classes of segments and output neural network results that are mapped to spaced apart clusters that are associated with different axes of the multi-dimensional domain. For example, assuming that there are three different classes of segments and there are three axis (e.g., x-axis, y-axis, and z-axis), then the pixels of the first class of segment will mapped to a first cluster (C1) associated with the x-axis, pixels of the second class of segment will mapped to a second cluster (C2) associated with the y-axis, and pixels of the third class of segment will mapped to a third cluster (C3) associated with the z-axis.

A cluster is associated with an axis when the neural network outputs of that cluster are proximate to the axis and/or are on the axis. Proximate may include, for example, the distance between the neural network outputs that belong to the cluster being closer to the axis associated with the cluster than to the other axes. The multiple repetitions of operations 210-216 may create the clusters and then modify the clusters by performing expansion operations and shrinking operations without reducing distances between the different clusters. The shrinking operations may increase the distance between clusters. A cluster may include neural network outputs that may belong to different clusters, and the expanding operation may guide a portion of a cluster to another cluster. For example, a first dataset may include two images being labeled to two classes of segments, “car” and “other.” It may be beneficial to expand a cluster of neural network outputs related to “other” pixels as it may be further split to multiple clusters.

Operations 210-216 may be evaluated per each image of multiple datasets. Images of at least two of the datasets (some of the datasets or all of datasets of the multiple datasets) may be labeled, by the processing logic, independently from each other and without using a common taxonomy. In some embodiments, the number of datasets and the number of images per dataset may be small. For example, the method may train on 3, 5, or 10 datasets, each having 5, 10, 20, 30, 40 or 50 images per dataset.

An example of a calculation of a normalized classification loss is expressed by formula 1 below, where the processing logic may calculate, per cluster, a mean (E′) and a standard deviation (S_{J}) of the cluster:

$$Formula 1$$

$${E}_{j} = mean ( {p}_{i} [ s = {S}_{j} ] )$$

$${S}_{j} \approx std ( {p}_{i} [ s = {S}_{j} ] ) ⇒ \sqrt{\frac{1}{\sum ( enpropy ( {s}_{i} ) > entropy ( {E}_{i} ) )} {\sum }_{n} ( enpropy ( {s}_{i} ) > entropy ( {E}_{i} ) ) \cdot {( {p}_{i} - {E}_{i} )}^{2}}$$

$$loss ( j , k ) = max ( margin - ( ‖ {E}_{j} - {E}_{k} ‖ - stdFactor \cdot ( {DS}_{j} + {DS}_{k} ) ) , 0 )$$

The normalized classification loss may be equal to:

normalized classification loss=mean(loss(j,k))+std(loss(j,k)).

In this example, each cluster is represented by its mean and standard deviation and the normalized classification loss function attempts to increase the distance between the means of the clusters while taking into account their standard deviation. The one-hot regulation loss may regularize the output of the neural network into a final classification, while minimizing entropy, and attempting to force the coordinates of the neural network outputs into one-hot representation represented by a set of coordinates that resemble, for example, [0 0 0 1 0]. This may render post processing such as K-means or K-Nearest-Neighbours redundant. The one-hot regulation loss function attempts to center the clusters about value “1” on each axis. In this case, the coordinates of each neural network output should have approximately one coordinate that equals the value “1,” and all other coordinates should equal the value zero (or values significantly smaller than “1.” An example of a calculation of a one-hot regulation loss is expressed by formula 2, below, where the processing logic can calculate an entropy (assuming that xi is a coordinate of a neural network output):

$$Entropy ( softmax ) = - {\sum }_{i} {x}_{i} log ( {x}_{i} ) \qquad Formula 2$$

The processing logic may calculate the standard deviation of the entropy (std(entropy)) and the mean of the entropy (mean(entropy)). The one-hot regulation loss equals std(entropy)+(mean(entropy). When both normalized classification loss and one-hot regulation loss are calculated, then the processing logic may calculate a weighted sum of both losses to provide the overall loss function to evaluate the neural network. Overall loss=α₁*(normalized classification loss)+α₂*(one-hot regulation loss). The values of al and α₂ may be determined in any manner, such as, for example, may be predefined, may be determined during iterations of operations 210-216, etc. It should be noted that the overall loss may be modified to center the cluster about a value that differs from another value (but should exceed a fraction of one that still keeps the cluster spaced apart from each other). In this case, this value may be the same for all axes. The normalized classification loss focuses on the distance between pairs of labels on the edge virtually connecting two clusters, thus filtering out the training noise caused by multi-modality in cluster and inter-distances to other classes.

An example of a calculation of a normalized classification loss is expressed by formula 3 below, where for means (Eⱼ and Eₖ) of two different clusters, the normalized classification loss is:

$$\frac{< {E}_{j} , {E}_{k} >}{‖ {E}_{j} ‖ \cdot ‖ {E}_{k} ‖} \qquad Formula 3$$

The normalized classification loss may accelerate the convergence of means different clusters to different axes that are normal to each other. The training of the neural network, and the formation of clusters that are spaced apart from each other wherein each cluster is proximate to a unique axis, greatly simplifies the decision about the class of segment that includes the tested pixel. The process involves searching the closest axes and searching for the dominant coordinate that may be the only non-zero coordinate of a neural network output. In some embodiments, the searching may include applying an argmax function, which is an operation that finds the argument that gives the maximum value from a target function.

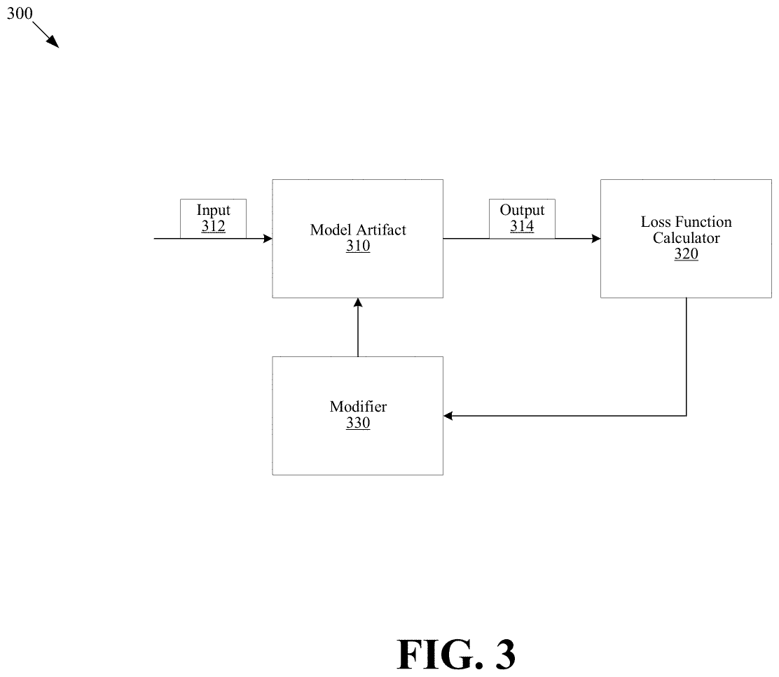

FIG. 3 depicts an illustration of training engine 300, according to aspects of the present disclosure. In some embodiments, training engine 300 is similar or the same as training engine 182 of FIG. 1. In some embodiments, training engine 300 includes model artifact 310 (e.g., a neural network model), loss function calculator 320, and modifier 330. Model artifact 310 can receive input 312, and generate output 314 in accordance, for example, with operation 212 of method 200. Loss function calculator may calculating at least one loss function in accordance, for example, with operation 214 of method 200. Modifier 330 may modify one or more weights of the model artifact 310 in accordance, for example, with operation 216 of method 200.

In some embodiments, method 200 may virtually merge different datasets and may perform additional classifications not defined by a user. For example, assuming that a first user defined a subset of the different classes of segments, method 200 may have pixels of images of the dataset provided by the user to be classified to more that the subset of classes defined by the user. This additional classification may be applied as long as the one or more additional classes do not contradict with the defined subset of classes.

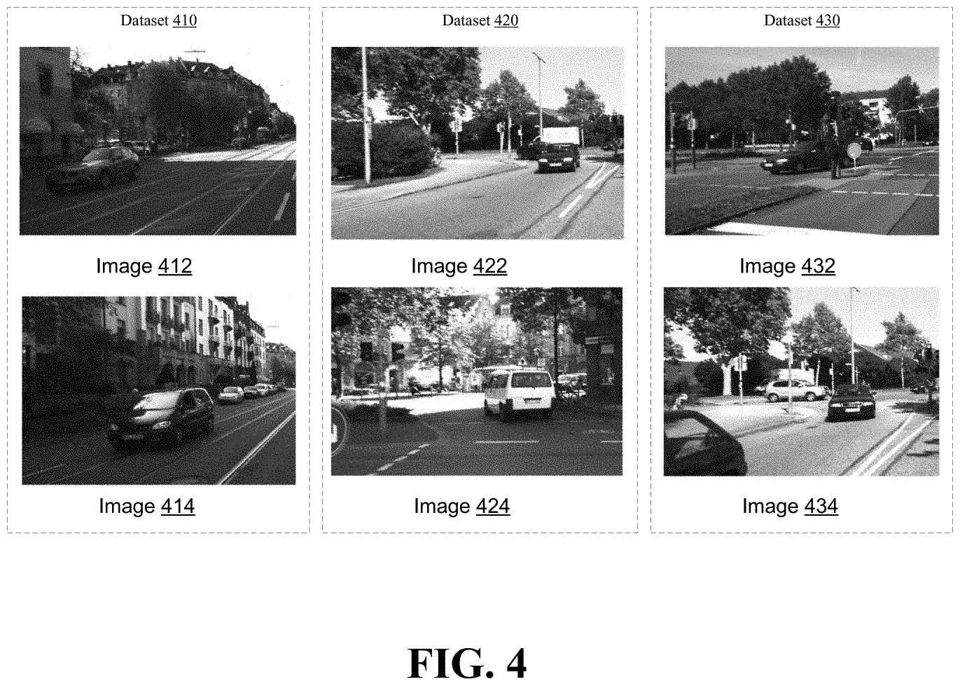

By way of illustrative example, FIG. 4 illustrates an example of three datasets 410, 420 and 430, each including two images. Dataset 410 includes images 412 and 414. Dataset 420 includes images 422 and 424. Dataset 430 includes images 432 and 434.

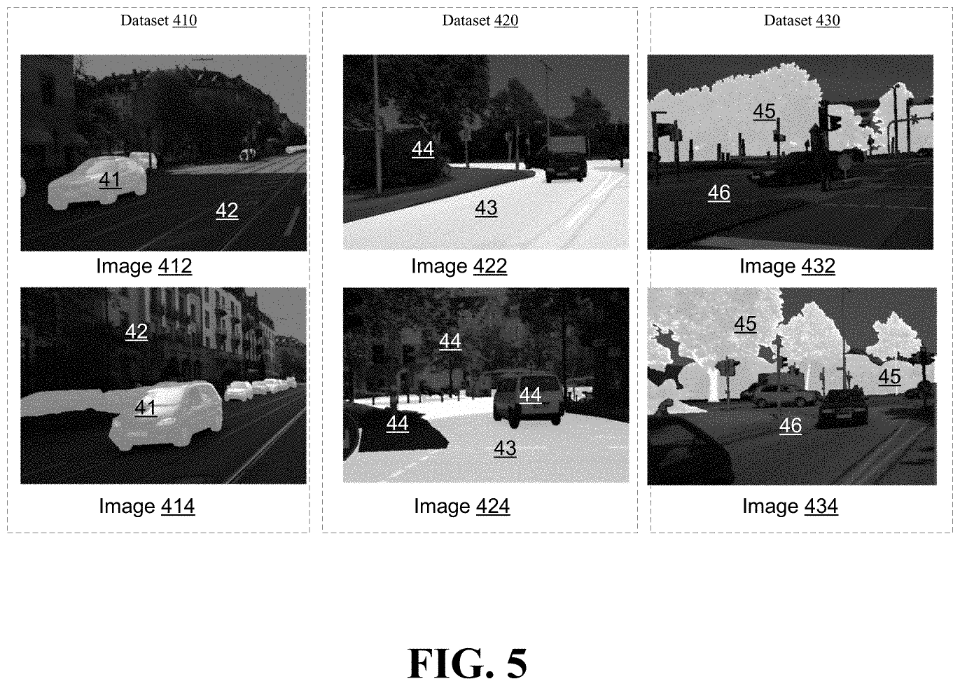

FIG. 5 illustrates datasets 410, 420, 430 and their respective initial classifications. In particular, dataset 410 includes the images 412 and 414 having their pixels labeled “car” (class 41) and “other” (class 42). Dataset 420 includes images 422 and 424 having their pixels labeled “road” (class 43) and “other” (class 44). Dataset 430 includes images 432 and 434 having their pixels labeled “trees” (class 45) and “other” (class 46). The neural network may be trained with all three subsets and may provide, for each user, a classification to at least one additional class of segments that is not defined by the user.

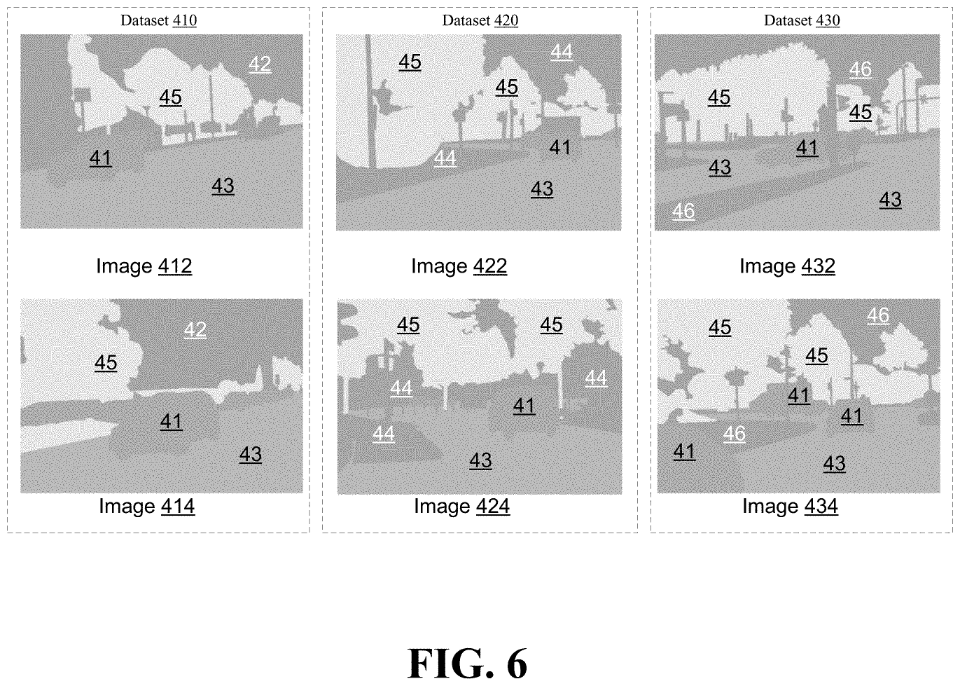

FIG. 6 illustrates the segmentation, after the training of the neural network, of the six images to more segments than originally defined by the users of these subsets. For example, the pixels of dataset 410 may be classified (and segments are formed) to a car class (class 41), to a tree class (class 45), to a road class (class 43) and to a modified “other” class of pixels (class 42) that includes pixels that do not belong to a car, a tree or a road.

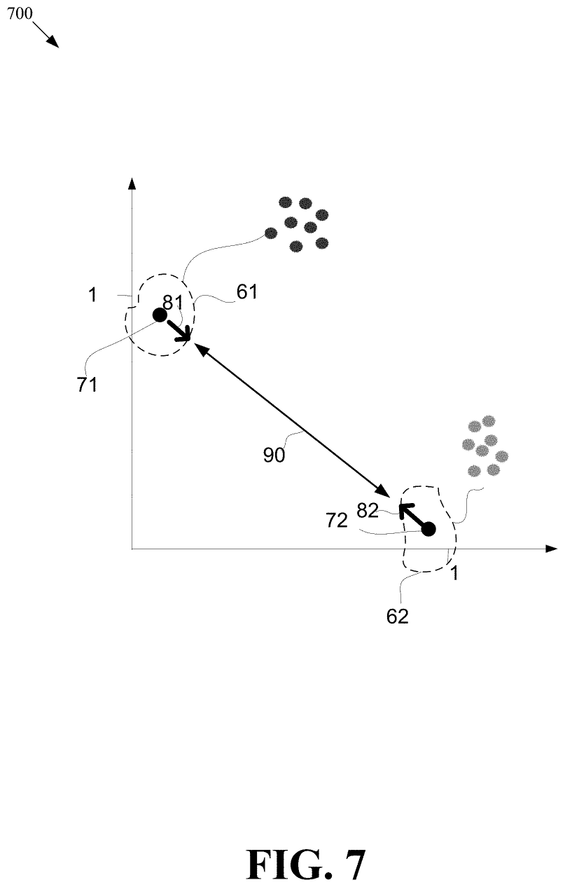

FIG. 7 is a graph 700 illustrating an example of two clusters, according to according to aspects of the present disclosure. Graph 700 illustrates first cluster 61, second cluster 62, the first mean 71 (the mean of the first cluster), the second mean 72 (the mean of the second cluster), the first standard deviation 81 (the standard deviation of the first cluster), the second standard deviation 82 (the standard deviation of the second cluster), and the distance 90 along a first direction related to the two clusters. The first cluster 61 and the second cluster 62 may expand along directions that differ from (for example are normal to) the first direction. A determination of which cluster includes a certain neural network output can be calculated by searching the most dominant (closest) axis.

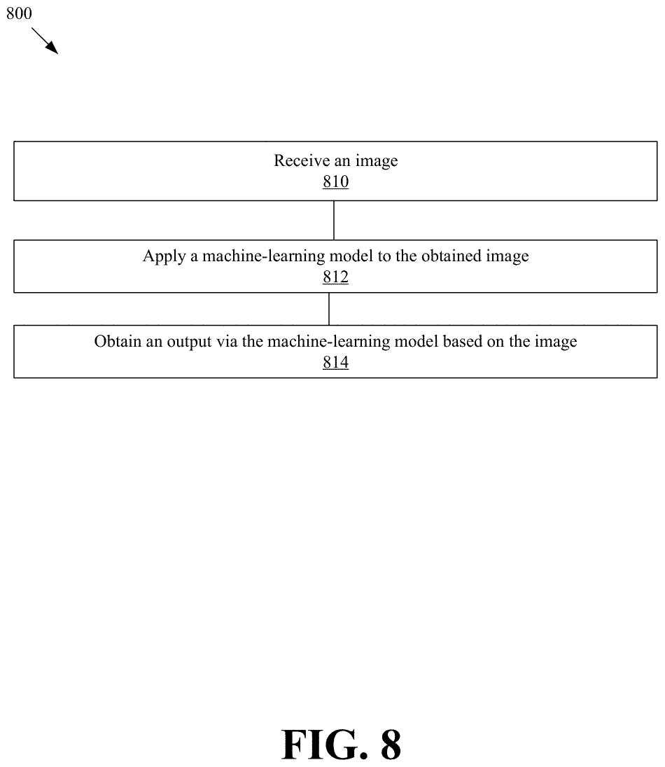

FIG. 8 is a flow chart of a method 800 for segmenting an image using the trained machine-learning model, according to aspects of the present disclosure. Method 800 is performed by processing logic that can include hardware (circuitry, dedicated logic, etc.), software (such as is run on a general purpose computer system or a dedicated machine), firmware, or some combination thereof. In one implementation, method 800 can be performed by a computer system, such as computer system architecture 100 of FIG. 1. In other or similar implementations, one or more operations of method 800 can be performed by one or more other machines not depicted in the figures. In some aspects, one or more operations of method 200 can be performed by server machine 170, server machine 180, and/or predictive server 112.

At operation 810, processing logic receives an image. The image may include a camera image, an electron microscope image, an optical inspection system image, a radar image, a sonar image, etc.

At operation 812, processing logic applies a machine-learning model (e.g. model 190) to the obtained image. The machine-learning model can be a neural network trained by a training process that included evaluating neural network outputs generated during the training process using loss function, as discussed in method 200 above, or method 900 below.

At operation 814, processing logic obtains an output of the machine-learning model based on the image. In some embodiments, to generate the output, the machine-learning model may segment the image. For example, for each pixel of the image, the machine-learning model may generate a result within a multi-dimensional domain. The results (generated by feeding the machine-learning model with pixels of different classes of segments) may be mapped to spaced-apart clusters that are associated with different axes of the multi-dimensional domain. The machine-learning model may then determine, for each pixel of multiple pixels of the image, a class of a segment that includes the pixel by finding a closest axis to the intermediate result. In some embodiments, the machine-learning model is a neural network, such as an end-to-end neural network or a U-net neural network.

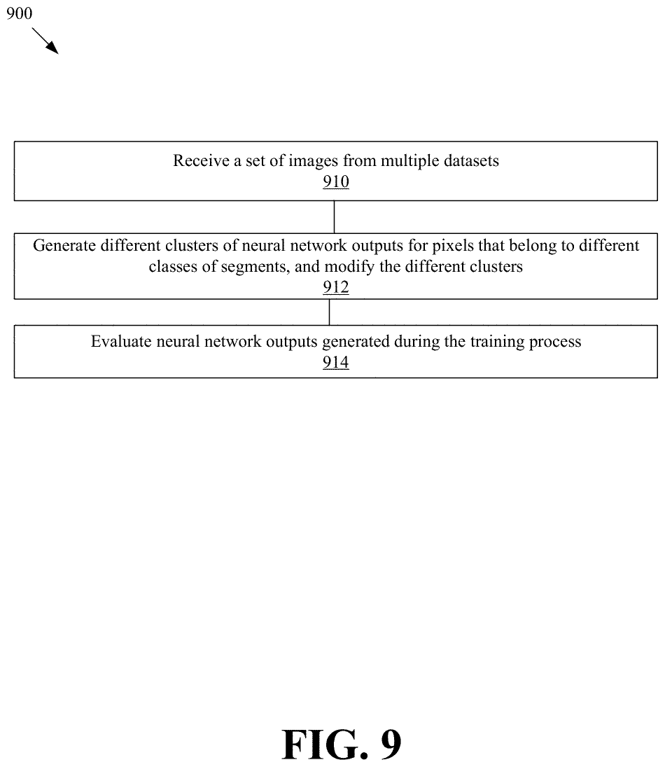

FIG. 9 is a flow chart of a method 900 for training a machine-learning model, according to aspects of the present disclosure. Method 900 is performed by processing logic that can include hardware (circuitry, dedicated logic, etc.), software (such as is run on a general purpose computer system or a dedicated machine), firmware, or some combination thereof. In one implementation, method 900 can be performed by a computer system, such as computer system architecture 100 of FIG. 1. In other or similar implementations, one or more operations of method 900 can be performed by one or more other machines not depicted in the figures. In some aspects, one or more operations of method 200 can be performed by server machine 170, server machine 180, and/or predictive server 112.

For simplicity of explanation, the methods are depicted and described as a series of acts. However, acts in accordance with this disclosure can occur in various orders and/or concurrently, and with other acts not presented and described herein. Furthermore, not all illustrated acts can be performed to implement the methods in accordance with the disclosed subject matter. In addition, those skilled in the art will understand and appreciate that the methods could alternatively be represented as a series of interrelated states via a state diagram or events. Additionally, it should be appreciated that the methods disclosed in this specification are capable of being stored on an article of manufacture to facilitate transporting and transferring such methods to computing devices. The term article of manufacture, as used herein, is intended to encompass a computer program accessible from any computer-readable device or storage media

At operation 910, the training process can include receiving a set of images from multiple datasets. The datasets may be labeled independently from each other and labeled without using a common taxonomy.

At operation 912, the processing logic can generate different clusters of neural network outputs for pixels that belong to different classes of segments, and modify the different clusters. Each segment may be represented by a mean of the cluster and a standard deviation of the cluster. In some embodiments, the processing logic may perform operation 912 by executing a normalized classification loss function. In some embodiments, the modifying may include performing expansion operations and/or shrinking operations without reducing distances between the different clusters.

At operation 914, the processing logic may evaluate neural network outputs generated during the training process. For example, the processing logic can perform the evaluation using at least one of the normalized classification loss function, the one-hot regulation loss, the cluster mean perpendicular inducing loss function, and/or any other applicable loss function. Representing the clusters by a limited number of parameters, for example by two parameter (e.g., their means and standard deviation), and applying the loss functions related to these limited number of parameter greatly simplifies the calculating of the loss functions and greatly simplifies the evaluation of the neural network during the training process.

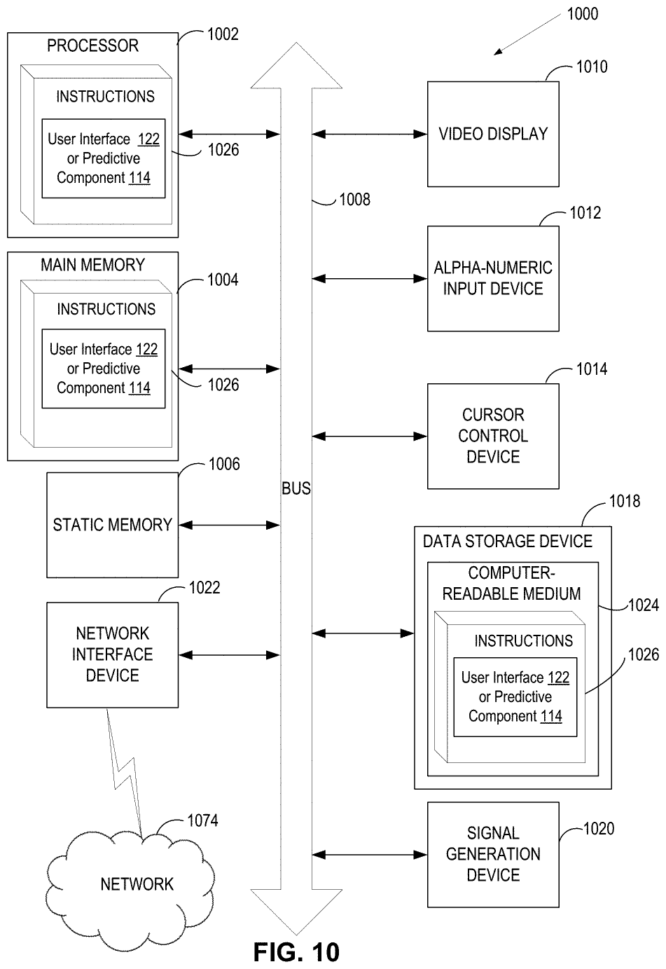

FIG. 10 is a block diagram illustrating a computer system 1000, according to certain embodiments. In some embodiments, computer system 1000 may be connected (e.g., via a network, such as a Local Area Network (LAN), an intranet, an extranet, or the Internet) to other computer systems. Computer system 1000 may operate in the capacity of a server or a client computer in a client-server environment, or as a peer computer in a peer-to-peer or distributed network environment. Computer system 1000 may be provided by a personal computer (PC), a tablet PC, a Set-Top Box (STB), a Personal Digital Assistant (PDA), a cellular telephone, a web appliance, a server, a network router, switch or bridge, or any device capable of executing a set of instructions (sequential or otherwise) that specify actions to be taken by that device. Further, the term “computer” shall include any collection of computers that individually or jointly execute a set (or multiple sets) of instructions to perform any one or more of the methods described herein.

In a further aspect, the computer system 1000 may include a processing device 1002, a volatile memory 1004 (e.g., Random Access Memory (RAM)), a non-volatile memory 1006 (e.g., Read-Only Memory (ROM) or Electrically-Erasable Programmable ROM (EEPROM)), and a data storage device 1016, which may communicate with each other via a bus 1008.

Processing device 1002 may be provided by one or more processors such as a general purpose processor (such as, for example, a Complex Instruction Set Computing (CISC) microprocessor, a Reduced Instruction Set Computing (RISC) microprocessor, a Very Long Instruction Word (VLIW) microprocessor, a microprocessor implementing other types of instruction sets, or a microprocessor implementing a combination of types of instruction sets) or a specialized processor (such as, for example, an Application Specific Integrated Circuit (ASIC), a Field Programmable Gate Array (FPGA), a Digital Signal Processor (DSP), or a network processor).

Computer system 1000 may further include a network interface device 1022 (e.g., coupled to network 1074). Computer system 1000 also may include a video display unit 1010 (e.g., an LCD), an alphanumeric input device 1012 (e.g., a keyboard), a cursor control device 1014 (e.g., a mouse), and a signal generation device 1020.

In some implementations, data storage device 1016 may include a non-transitory computer-readable storage medium 1024 on which may store instructions 1026 encoding any one or more of the methods or functions described herein, including instructions encoding components of FIG. 1 (e.g., user interface 122, predictive component 114, etc.) and for implementing methods described herein.

Instructions 1026 may also reside, completely or partially, within volatile memory 1004 and/or within processing device 1002 during execution thereof by computer system 1000, hence, volatile memory 1004 and processing device 1002 may also constitute machine-readable storage media.

While computer-readable storage medium 1024 is shown in the illustrative examples as a single medium, the term “computer-readable storage medium” shall include a single medium or multiple media (e.g., a centralized or distributed database, and/or associated caches and servers) that store the one or more sets of executable instructions. The term “computer-readable storage medium” shall also include any tangible medium that is capable of storing or encoding a set of instructions for execution by a computer that cause the computer to perform any one or more of the methods described herein. The term “computer-readable storage medium” shall include, but not be limited to, solid-state memories, optical media, and magnetic media.

The methods, components, and features described herein may be implemented by discrete hardware components or may be integrated in the functionality of other hardware components such as ASICS, FPGAs, DSPs or similar devices. In addition, the methods, components, and features may be implemented by firmware modules or functional circuitry within hardware devices. Further, the methods, components, and features may be implemented in any combination of hardware devices and computer program components, or in computer programs.

Unless specifically stated otherwise, terms such as “receiving,” “performing,” “providing,” “obtaining,” “causing,” “accessing,” “determining,” “adding,” “using,” “training,” or the like, refer to actions and processes performed or implemented by computer systems that manipulates and transforms data represented as physical (electronic) quantities within the computer system registers and memories into other data similarly represented as physical quantities within the computer system memories or registers or other such information storage, transmission or display devices. Also, the terms “first,” “second,” “third,” “fourth,” etc. as used herein are meant as labels to distinguish among different elements and may not have an ordinal meaning according to their numerical designation.

Examples described herein also relate to an apparatus for performing the methods described herein. This apparatus may be specially constructed for performing the methods described herein, or it may include a general purpose computer system selectively programmed by a computer program stored in the computer system. Such a computer program may be stored in a computer-readable tangible storage medium.

The methods and illustrative examples described herein are not inherently related to any particular computer or other apparatus. Various general purpose systems may be used in accordance with the teachings described herein, or it may prove convenient to construct more specialized apparatus to perform methods described herein and/or each of their individual functions, routines, subroutines, or operations. Examples of the structure for a variety of these systems are set forth in the description above.

The above description is intended to be illustrative, and not restrictive. Although the present disclosure has been described with references to specific illustrative examples and implementations, it will be recognized that the present disclosure is not limited to the examples and implementations described. The scope of the disclosure should be determined with reference to the following claims, along with the full scope of equivalents to which the claims are entitled.

1. A method, comprising:
receiving, by a processing device, an image;
applying a machine learning model to the image, wherein the machine-learning model is trained by a training process comprising evaluating training outputs generated during the training process using a loss function;
obtaining, for each pixel of multiple pixels of the image, an output of the machine learning model within a multi-dimensional domain, wherein the output is obtained by providing the machine-learning model with pixels of different classes of segments of the image that are mapped to spaced apart clusters associated with different axes of the multi-dimensional domain; and
determining, using the machine-learning model and for each pixel of multiple pixels of the image, a class of a segment that comprises the pixel by finding a closest axis to the output.

2. The method of claim 1, wherein the machine-learning model comprises a neural network.

3. The method of claim 1, wherein the loss function comprises at least one of a normalized classification loss function, a one-hot regulation loss function, or a cluster mean perpendicular inducing loss function.

4. The method of claim 1, wherein the training process comprises feeding the machine-learning model with images from a plurality of datasets, wherein images of at least two of the datasets of the plurality of datasets are labeled independently from each other and without using a common taxonomy.

5. The method of claim 1, wherein the training process further comprises forming different clusters of machine-learning model results for pixels that belong to different classes of segments and modifying the different clusters, wherein the modifying comprises performing expansion operations and shrinking operations without reducing distances between the different clusters.

6. The method of claim 5, wherein at least one of the forming and the modifying is based, at least in part, on applying a normalized classification loss function.

7. The method of claim 1, wherein the training process comprises forming different clusters of machine-learning model results for pixels that belong to different classes of segments, representing each cluster by a mean of the cluster and a standard deviation of the cluster, and modifying the different clusters, wherein the modifying comprises performing expansion operations and shrinking operations without reducing distances between the means of the different clusters.

8. The method of claim 1, wherein the training process comprises evaluating machine-learning model outputs generated during the training process using at least one of a normalized classification loss function, a one-hot regulation loss function, or a cluster mean perpendicular inducing loss function.

9. A method, comprising:
providing an image as input to a machine-learning model, wherein the machine-learning model is trained by a training process comprising inputting into the machine-learning model a plurality of datasets, wherein images of at least two of the plurality of datasets are labeled independently from each other and without using a common taxonomy;
obtaining, for each pixel of multiple pixels of the image, an output of the machine learning model within a multi-dimensional domain, wherein the output is obtained by providing the machine-learning model with pixels of different classes of segments mapped to spaced apart clusters that are associated with different axes of the multi-dimensional domain; and
determining, using the machine-learning model and for each pixel of multiple pixels of the image, a class of a segment that comprises the pixel by finding a closest axis to the output.

10. The method of claim 9, wherein the machine-learning model comprises a neural network.

11. The method of claim 9, wherein the training process comprises evaluating training outputs generated during the training process using a loss function.

12. The method of claim 11, wherein the loss function comprises at least one of a normalized classification loss function, a one-hot regulation loss function, or a cluster mean perpendicular inducing loss function.

13. The method of claim 9, wherein the training process further comprises forming different clusters of machine-learning model results for pixels that belong to different classes of segments and modifying the different clusters, wherein the modifying comprises performing expansion operations and shrinking operations without reducing distances between the different clusters.

14. The method of claim 13, wherein at least one of the forming or the modifying is based, at least in part, on applying a normalized classification loss function.

15. The method of claim 9, wherein the training process comprises forming different clusters of machine-learning model results for pixels that belong to different classes of segments, representing each cluster by a mean of the cluster and a standard deviation of the cluster, and modifying the different clusters, wherein the modifying comprises performing expansion operations and shrinking operations without reducing distances between the means of the different clusters.

16. The method according to claim 9, wherein the training process comprises evaluating machine-learning model outputs generated during the training process using at least one of a normalized classification loss function, a one-hot regulation loss function, or a cluster mean perpendicular inducing loss function.

17. A system comprising:
a memory; and
a processing device operatively coupled with the memory, to perform operations comprising:
providing an image as input to a machine-learning model, wherein the machine-learning model is trained by a training process comprising evaluating training outputs generated during the training process using a loss function;
obtaining, for each pixel of multiple pixels of the image, an output of the machine learning model within a multi-dimensional domain, wherein the output is obtained by providing the machine-learning model with pixels of different classes of segments mapped to spaced apart clusters that are associated with different axes of the multi-dimensional domain; and
determining, using the machine-learning model and for each pixel of multiple pixels of the image, a class of a segment that comprises the pixel by finding a closest axis to the output.

18. The system of claim 17, wherein the loss function comprises at least one of a normalized classification loss function, a one-hot regulation loss function, or a cluster mean perpendicular inducing loss function.

19. The system of claim 17, wherein the training process comprises feeding the machine-learning model with images from a plurality of datasets, wherein images of at least two of the datasets of the plurality of datasets are labeled independently from each other and without using a common taxonomy.

20. The system of claim 17, wherein the training process further comprises forming different clusters of machine-learning model results for pixels that belong to different classes of segments and modifying the different clusters, wherein the modifying comprises performing expansion operations and shrinking operations without reducing distances between the different clusters.
